(19) United States
(12) Patent Application Publication
(10) Pub. No.: US 2019/0367172 A1
(43) Pub. Date: Dec. 5, 2019

(54) WEARABLE MICROCLIMATE HEATER AND COOLER DEVICE

(71) Applicant: Carver Scientific, Inc., Baton Rouge, LA (US)

(72) Inventors: David Reginald Carver, Baton Rouge, LA (US); Ritchie Don Priddy, St. Francisville, LA (US); Sean William Reynolds, Baton Rouge, LA (US); Ronnie K. Bilbo, Lubbock, TX (US); Celia Vento, Lubbock, TX (US)

(73) Assignee: Carver Scientific, Inc., Baton Rouge, LA (US)

(21) Appl. No.: 16/130,481

(22) Filed: Sep. 13, 2018

Related U.S. Application Data
(60) Provisional application No. 62/687,593, filed on Jun. 20, 2018.
(60) Provisional application No. 62/677,555, filed on May 29, 2018.

(51) Int. Cl. B64D 13/08; F25B 21/02; A41D 1/08; A43B 7/04

(52) U.S. Cl. CPC B64D 13/08; F25B 21/02; A41D 3/005; A43B 7/04; A41D 1/08

(57) ABSTRACT

A wearable heater and/or cooler device can include one or more fluid pumps, one or more conduits, and one or more chambers. The fluid pumps can be configured for generating flow of a fluid and comprise inlets and outlets. The conduits have first end portions and second end portions, and the first end portions of the conduits can be coupled to the outlets of the fluid pumps. The chambers can be coupled to second end portions of the conduits such that the fluid flows from the fluid pumps, through the conduits, and into the chambers. The chambers can be configured to enhance the desired thermal transport characteristics of the fluid for thermal transfer adjacent to a wearer's body.

### CROSS-REFERENCE TO RELATED APPLICATIONS

This application claims the benefit of U.S. Provisional Application Nos. 62/687,593, filed Jun. 20, 2018, and 62/677,555, filed May 29, 2018. Each related application is incorporated by reference herein.

### ACKNOWLEDGMENT OF GOVERNMENT SUPPORT

This invention was made with government support under contract no. FA8650-17-C-6810 awarded by the U.S. Department of the Air Force. The government has certain rights in the invention.

### FIELD

This disclosure relates generally to the field of personal environmental cooling and heating and more specifically to devices and methods related thereto.

### BACKGROUND

Environmental temperature extremes pose serious stresses for the human body and effect comfort, performance, and/or safety. Even mild heat illness and dehydration can significantly degrade worker performance, and more. Likewise, exposure to cold weather can lead to serious health issues, including hypothermia, frostbite, and other detrimental effects. Extreme temperature conditions can place an individual in danger of performance reduction, injury, or death if not mitigated.

There are many activities and professions that require personal exposure to extreme (high and low) environmental temperatures for prolonged periods of time while wearing protective clothing and gear. These activities and professions sometimes also require unhindered freedom of movement without being tethered to a heavy microclimate cooling and heating device or being required to carry heavy energy storage devices for heating or cooling. Some examples include: soldiers (particularly dismounted soldiers), fire fighters, police, construction workers, oil and gas workers, hazardous materials (“HAZMAT”) workers, athletes, recreationalists (e.g., hikers, campers, hunters, etc.) and others who are exposed to extreme temperatures. The problems of heating or cooling at the personal environmental level are exacerbated if the person is required to wear Personal Protective Equipment (“PPE”) or heavy protective garments.

Research shows that resting humans maintain a core body temperature that is typically between 36.5° C. and 37.5° C. (97.7° F. and 99.5° F.). The safe and effective operating range for the body extends a bit higher as core temperature can approach 39° C. (102.2° F.) during exercise with no ill effects. This finding led to the U.S. Army developing its FM 20-11 safety threshold of 39° C. for a maximum core body temperature. Heat casualties can be expected in less than one hour at ambient air temperatures above 86° F. (30° C.) even at low activity levels. Oftentimes, a soldier may encounter both hot days and cold nights on the same mission. These findings can be applied to all recreational, athletic, military activities, comfort requirements, and industries where workers are exposed to extreme temperatures.

Accordingly, there is a need for improved equipment for individuals who are exposed to extreme temperatures.

### SUMMARY

Described herein are portable personal wearable microclimate heating and cooling devices that are lightweight, low power, and do not restrict a person's movements or inhibit their ability to wear protective, functional, and/or performance gear, while providing effective temperature relief.

In some embodiments, the wearable personal environmental cooling and heating system is compatible with protective garments (including body armor, recreational equipment, protective gear, and/or functional gear) and/or comprises an air dispersion garment (or pad). In certain embodiments, the system can include one or more additional features such as a microblower, a heat pump to provide cooling and heating, other resistance heating and cooling, and/or an energy storage device and/or energy generating device to provide power for operation.

As an example, the air dispersion garment can comprise grooved pads placed on the body's torso (e.g., front, back, sides), and can be in the form of a vest located adjacent to the body, and under PPE such as fire protection clothing. Means for delivering air to the air dispersion garment may comprise flexible air conduction passages with sufficient strength so as not to collapse under the weight of heavy outer garments. The air dispersion garment and passages can be placed in a manner that do not hinder or restrict movements and maintains comfort.

In certain embodiments, the device, as it is used by the operator, can be used to provide for the pumping action of the cooling or heating fluid by the operators own movements. In this embodiment the actuation of one-way valves can force the air or fluid to circulate as required for heating or cooling without the use of an electrically-actuated active transport such as a microblower.

In some embodiments, a microblower can be part of the air delivery mechanism to provide ambient air to the dispersion garment. In some configurations, a chiller and/or heater may be used to cool or heat the air before or after it enters the air delivery mechanism and then be delivered before or after to the dispersion garment.

In one representative embodiment, a wearable heater and/or cooler comprises one or more fluid pumps, one or more conduits, and one or more chambers. The fluid pumps are configured for generating flow of a fluid and comprise inlets and outlets. The conduits have first end portions and second end portions. The first end portions of the conduits are coupled to the outlets of the fluid pumps. The chambers are coupled to second end portions of the conduits such that the fluid flows from the fluid pumps, through the conduits, and into the chambers. The chambers are configured for allowing the fluid to circulate adjacent to a wearer's body.

In some embodiments, one or more of the chambers comprises a chamber area configured to enhance desired thermal transfer characteristics between the wearer's body and the fluid.

In some embodiments, the wearable heater and/or cooler device further comprises one or more absorbent materials disposed within and/or along the chambers and configured to absorb fluid from the wearer's body.

In some embodiments, the absorbent materials includes a water-absorbing and/or high-surface area material.

In some embodiments, at least one of the fluid pumps is a passive fluid pump configured for generating flow of the fluid by movement of the wearer and/or shifting mass of the wearer, and the passive fluid pump comprises one or more fluid passages and one or more one-way valves.

In some embodiments, at least one of the fluid pumps comprises an electrically-powered microblower.

In some embodiments, one or more of the chambers are configured to be placed at or adjacent to a core of the wearer. In some embodiments, one or more of the chambers are configured to be placed at or adjacent to a chest of the wearer. In some embodiments, one or more of the chambers are configured to be placed at or adjacent to a back of the wearer. In some embodiments, one or more of the chambers are configured to be disposed at or adjacent to a foot of the wearer. In some embodiments, one or more of the chambers are configured to be disposed at or adjacent to a head of the wearer. In some embodiments, one or more of the chambers are configured to be disposed at or adjacent to a neck of the wearer. In some embodiments, one or more of the chambers are configured to be disposed at or adjacent to a leg of the wearer. In some embodiments, one or more of the chambers are configured to be disposed at or adjacent to a knee of the wearer. In some embodiments, one or more of the chambers are configured to be disposed at or adjacent to an arm of the wearer. In some embodiments, one or more of the chambers are configured to be disposed at or adjacent to an elbow of the wearer. In some embodiments, one or more of the chambers are configured to be located on or adjacent to the human body.

In some embodiments, the fluid pumps include at least one passive fluid pump and at least one active fluid pump.

In some embodiments, at least one of the fluid pumps comprises a housing with a plurality of outlets. Each outlet of the housing is configured to direct the fluid in a direction, the direction being different than a direction in which the other outlets of the housing direct the fluid. Each outlet of the housing is coupled to a first end portion of a respective conduit.

In another representative embodiment, a method is provided. The method comprises wearing a heater and/or cooler device that includes, a fluid pump configured for generating flow of a fluid, wherein the fluid pump comprises an inlet and an outlet, a conduit having a first end portion and a second end portion, wherein the first end portion of the conduit is coupled to the outlet of the fluid pump, and a chamber coupled to the second end portion of the conduit such that the fluid flows from the fluid pump, through the conduit, and into the chamber, wherein chamber is configured for allowing the fluid to circulate adjacent to a wearer's body. The method further includes activating the fluid pump to generate flow of the fluid from the fluid pump, through the conduit, and to the chamber.

In some embodiments, activating the fluid pump comprises compressing a fluid passage with a force generated by body weight and/or motion of the wearer.

The foregoing and other objects, features, and/or advantages of the disclosed technology will become more apparent from the following detailed description, claims, drawings, and/or appendix, which proceeds with reference to the accompanying figures.

### BRIEF DESCRIPTION OF THE DRAWINGS

FIG. 1 shows front elevation view of an exemplary embodiment of a wearable microclimate heating and cooling device, being worn by a wearer.

FIG. 2A shows a front perspective view of the exterior of the wearable microclimate heating and cooling device.

FIG. 2B shows a back perspective view of the exterior of the wearable microclimate heating and cooling device.

FIG. 3A shows a front perspective view of the interior of the wearable microclimate heating and cooling device.

FIG. 3B shows a back perspective view of the interior of the wearable microclimate heating and cooling device.

FIG. 4 shows a detail view of the front, interior of the wearable microclimate heating and cooling device.

FIG. 5 shows a perspective view of an exemplary insert of the wearable microclimate heating and cooling device coupled to various other components of the device.

FIG. 6 shows a perspective view of another exemplary insert of the wearable microclimate heating and cooling device coupled to various other components of the device.

FIG. 7 shows a side perspective view of an exemplary microblower of the wearable microclimate heating and cooling device.

FIG. 8 shows a cross-sectional view of the microblower of FIG. 7.

FIG. 9 shows a partial cross-sectional view of an exemplary outlet portion of the microblower of FIG. 7.

FIG. 10 shows a partial cross-sectional view of an exemplary male fitting of the wearable microclimate heating and cooling device.

FIG. 11 shows a perspective view of an exemplary connector of the wearable microclimate heating and cooling device.

FIG. 12 shows a perspective view of an exemplary bag for the micropump of the wearable microclimate heating and cooling device.

FIG. 13 shows a perspective view of an exemplary embodiment of a drying bag which can be used with the wearable microclimate heating and cooling device.

FIG. 14 shows a schematic diagram of an exemplary passive fluid pump that can be used of the wearable microclimate heating and cooling device.

FIG. 15 shows a perspective view of an exemplary article of footwear with a passive fluid pump.

FIG. 16 shows a plan view of an exemplary knee/elbow pad having a passive fluid pump.

FIG. 17 shows an elevation view of an exemplary vest having a passive fluid pump.

FIG. 18A depicts a chart showing temperature and relative humidity data inside the wearable microclimate heating and cooling device when the microblower is “off.”

FIG. 18B depicts a chart showing temperature and relative humidity data inside the wearable microclimate heating and cooling device when the microblower is “on.”

FIG. 19A depicts a thermal image of the wearer after performing physical activity while the microblower is “off.”

FIG. 19B depicts a thermal image of the wearer after performing physical activity while the microblower is “on.”

FIG. 20 shows a perspective view of an embodiment of a chiller/heater device for the wearable microclimate heating and cooling device.

### DETAILED DESCRIPTION

For purposes of this description, certain aspects, advantages, and novel features of the embodiments of this disclosure are described herein. The described methods, systems, and apparatus should not be construed as limiting in any way. Features, characteristics, and/or groups described in conjunction with a particular aspect, embodiment or example are to be understood to be applicable to any other aspect, embodiment or example described herein unless incompatible therewith. All of the features disclosed in this specification (including any accompanying claims, abstract, and drawings), and/or all of the steps of any method or process so disclosed, may be combined in any combination, except combinations where at least some of such features and/or steps are mutually exclusive. The disclosure is not restricted to the details of any foregoing embodiments. The disclosure extends to any novel one, or any novel combination, of the features disclosed in this specification (including any accompanying claims, abstract, and drawings), or to any novel one, or any novel combination, of the steps of any method or process so disclosed.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods, systems, and apparatus can be used in conjunction with other systems, methods, and apparatus.

The explanations of terms and abbreviations herein are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

As used herein, the term “and/or” used between the last two elements of a list of elements means any one of, or any combination of, the listed elements. For example, the phrase “A, B, and/or C” means “A,” “B,” “C,” “A and B,” “A and C,” “B and C,” or “A, B, and C.”

As used herein, the terms “attached” and “coupled” generally mean physically connected or linked, which includes items that are directly attached/coupled and items that are attached/coupled with intermediate elements between the attached/coupled items, unless specifically stated to the contrary.

Unless otherwise indicated, all numbers expressing quantities of components, temperatures, times, and so forth, as used in the specification or claims are to be understood as being modified by the term “about.” Accordingly, unless otherwise indicated, implicitly or explicitly, the numerical parameters set forth are approximations that may depend on the desired properties sought and/or limits of detection under standard test conditions/methods as known to those of ordinary skill in the art. When directly and explicitly distinguishing embodiments from discussed prior art, the embodiment numbers are not approximating unless the word “about” is recited.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the detailed description, claims, abstract, and drawings.

As used herein a “fluid” is a moveable material of indefinite shape capable of taking on different forms through the use of low energy forces. Examples include air, water, gases, liquids, and other materials that are capable of being utilized as circulation materials.

As used herein a “fluid pump” is a pump configured to move a fluid. This definition includes using the pumping action of the one-way valves to move a fluid through the circulation system in either a closed-loop configuration or an open-loop configuration.

A “microblower” is a small, compact fluid blower that can be attached to and supported by a garment worn by a human. For example, a microblower can be a small, compact fan configured as an axial or radial blower and sized such that it can be attached to and supported by a vest worn by a human. A microblower is an active fluid pump powered by electrical means.

A “passive fluid pump” is a fluid movement pump that is powered at least partly by the wearer's body weight and/or bodily motion. For example, a non-electrically powered pump that uses a wearer's walking motion to cause or assist fluid circulation is a passive fluid pump.

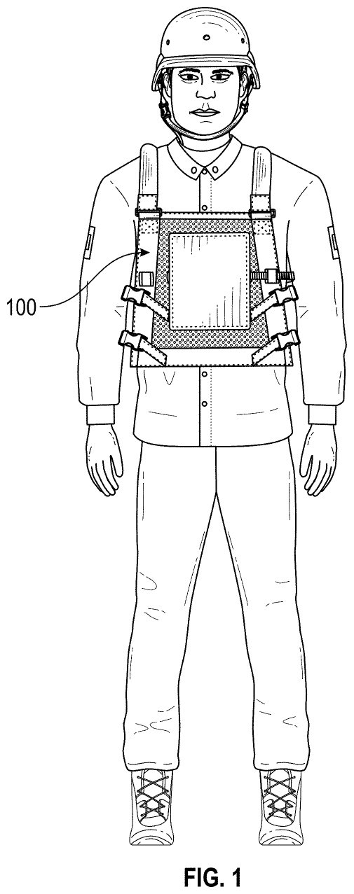

Described herein are portable personal wearable microclimate heating and cooling devices that providing effective temperature relief and are lightweight, low power, and do not restrict a person's movements or inhibit their ability to wear protective, functional, and/or performance gear. FIG. 1 shows an exemplary microclimate heating and cooling (“MCHC”) vest 100 being worn by a wearer. The vest 100 can be used to cool and/or heat the wearer, as further described below.

Although vests are the primary examples of MCHC devices in this disclosure, the disclosed MCHC devices can be incorporated into other types of wearable apparel. For example, the MCHC technology can be incorporated into shirts, jackets, coats, pants, hats, gloves, bags (e.g., backpacks), hazardous materials (“HAZMAT”) suits, Explosive Ordnance Disposal (“EOD”) suit, Personal Protective Equipment (“PPE”) suits (e.g., firefighting), and/or any other type of wearable apparel.

The vests can use fluid pumps such as blowers or other types of fluid delivery mechanisms to circulate air on or adjacent to the wearers body.

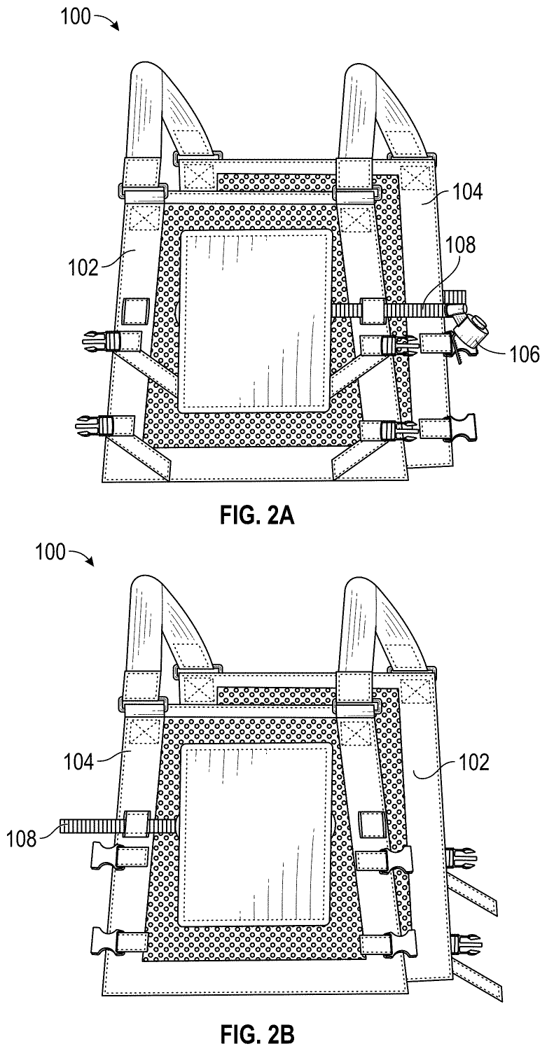

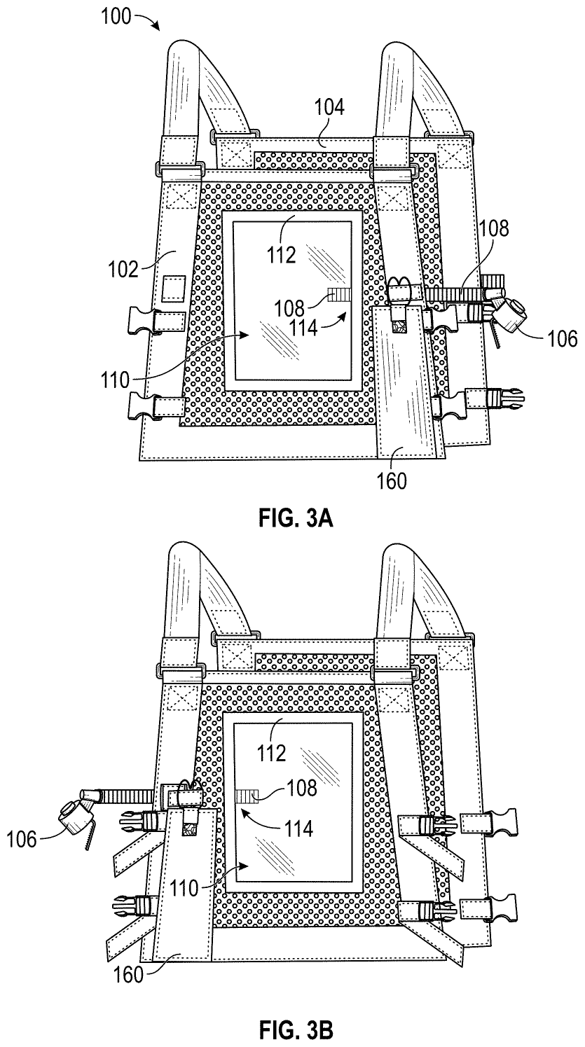

Referring now to FIGS. 2A-2B, the vest 100 can comprise a front panel 102, a back panel 104, one or more microblowers 106 (e.g., one in the illustrated embodiment—see FIG. 2A), and tubes or conduits 108. Although not shown, in some embodiments, the vest 100 can have side panels. Each conduit 108 can be coupled to the microblower 106 and can extend from the microblower to one of the panels 102, 104, as shown in FIGS. 3A-3B. The microblower 106 can be configured to generate fluid flow (e.g., air flow) through the conduits 108 to cooling and/or heating zones disposed on the panels 102, 104.

As shown in FIG. 1, the cooling/heating zones or areas can, in some embodiments, be located on the vest so as to be disposed over or adjacent to center regions of the wearer's body (e.g., regions with high blood flow such as the chest and/or back). In other embodiments, the cooling/heating zones can be located on additional or alternative areas of the vest which corresponding to other portions of the wearer's body. In some embodiments, the cooling/heating zones can include one or more chambers and/or passages that allow air flow to these centralized areas of the body. For example, in the illustrated embodiment, the vest 100 comprises two cooling/heating chambers 110 (i.e., one on the front panel 102 and one on the back panel 104). In other embodiments, the vest 100 can have only one cooling/heating chamber (e.g., one the front panel 102) or can have more than two cooling/heating chambers (e.g., 3-10).

In some embodiments, the chambers 110 can each comprise one or more boundary or support walls 112 defining the chamber. The support walls 112 can be configured to contact the wearer body (e.g., their chest or back). The support walls 112 can also be formed of a sufficiently rigid material so that interior portion of the chambers 110 remains spaced from the wearer's body when the support walls contacts the wearers body. In this manner, the support walls create a pocket that to improve air circulation within the chamber 110. For example, in the illustrated embodiment, the support walls 112 comprise a foam layer extending around the perimeter of the chamber 110. In other embodiments, the support walls can include various other types of materials such as polymeric and/or composite materials.

The support walls 112 of each chamber 110 can comprise an opening 114 to which the conduits 108 are coupled and/or extend through. The opening 114 can thus allow the air flowing through the conduits 108 to flow into the chambers 110. In some embodiments, the openings 114 can be sized and/or configured such that the conduits 108 can pass through the support walls 112, as shown in FIGS. 3A-3B.

The chambers 110 can be comprise various shapes. For example, the chamber 110 comprises a rectangular shape in the illustrated embodiments. In other embodiments, the chamber 110 can be circular, ovular, hourglass-shaped, and/or other shapes and combinations of shapes.

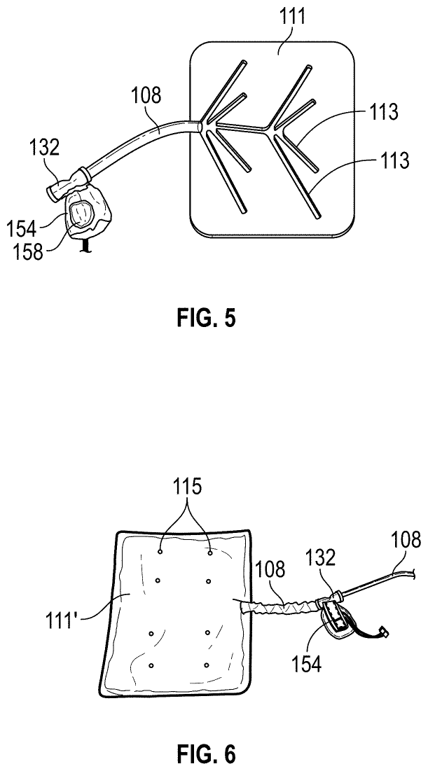

As shown in FIG. 5, in some embodiments, the chambers 110 can also comprise one or more inserts 111 having one or more flow channels or passageways 113. The inserts can be used in combination with or as an alternative to the support walls 112. The inserts 111 can be formed of a flexible but relatively firm material (e.g., high-density foam) such that the passageways 113 do not collapse when the insert 111 is pressed against the wearer's body.

FIG. 6 shows another insert 111′ that can be used in lieu of the insert 111. Rather than passageways 113, the insert 111′ has openings 115 formed therein (e.g., eight in the illustrated embodiment).

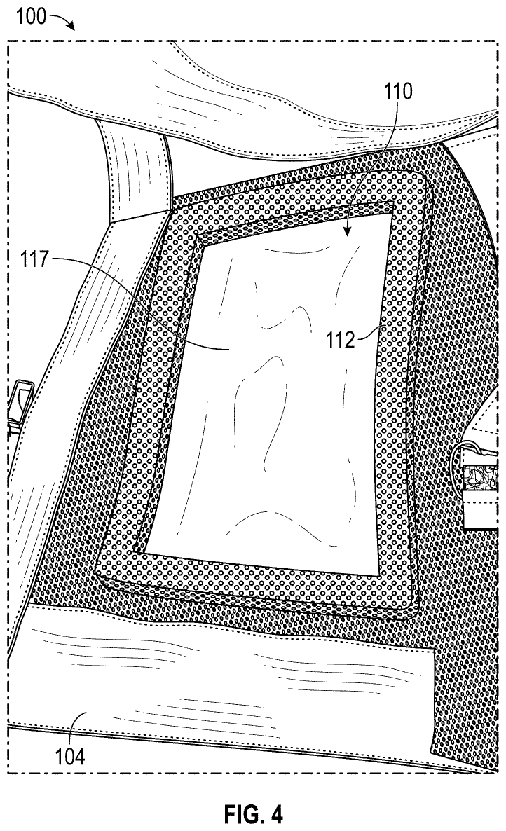

Referring again to FIG. 4, absorbent materials 117 can be disposed in the chamber 110. The absorbent materials can be configured to absorb moisture (e.g., perspiration, water, and/or other fluids) from the wearer. The absorbent materials 117 can include various types of material including a water absorbing high-surface area material, dry-fit fabric, cotton tee-shirt, and/or performance fabrics (e.g., polyester, polypropylene, polyesters, and/or polyamides), and/or various other absorbent and/or wicking materials. In embodiments with an insert (e.g., insert 111 and/or insert 111′), the absorbent materials 117 can cover the insert.

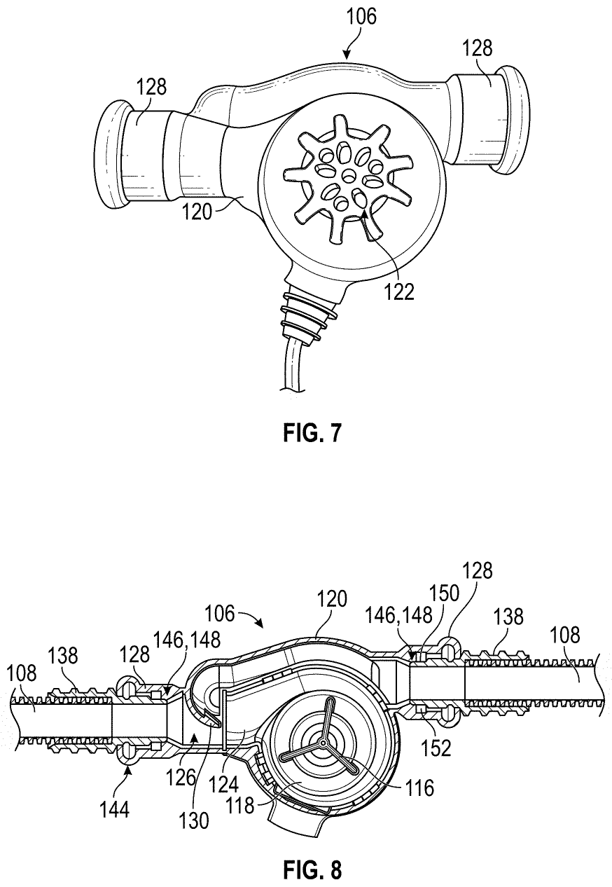

FIGS. 7-8 show an exemplary embodiment of the microblower 106, which is configured to generate airflow through the conduits 108 and chambers 110. In the illustrated embodiment, the vest 100 comprises only one microblower (i.e., one microblower coupled to both the front panel 102 and the back panel 104). In other embodiments, a vest can include a plurality of microblowers. For example, a vest can include a separate microblower for each panel (e.g., a first microblower for the front panel 102 and a second microblower for the back panel 104) or more than one microblower per panel.

As shown in FIG. 8, the microblower 106 can comprise a blower mechanism 116, a first housing 118 (e.g., inner), and an optional second housing 120 (e.g., outer). The first housing 118 can be coupled to and encase the blower mechanism 116 and have an inlet portion 122 (FIG. 7) and an outlet portion 124. The second housing 120 can be coupled to and encase a least a portion of the first housing 118. The second housing 120 can include an inlet portion 126 coupled to the outlet portion 124 of the first housing 118, and one or more outlet portions 128 (e.g., two in the illustrated embodiment) coupled to the conduits 108. As such, the blower mechanism 116 draws air into the first housing 118 through the inlet portion 122 and accelerates the air. The first housing 118 directs the accelerated air to the outlet portion 124 of the first housing and the inlet portion 126 of the second housing 120. The second housing 120 further comprises a flow separator 130 that splits the airflow into a plurality of channels of the second housing through which the air flows until reaching the outlet portions 128. The air then flows through the outlet portions 128 of the second housing 120 and into the conduits 108.

Although the outlet portions 128 of the second housing 120 are directed in opposite, parallel directions (e.g., to the left and right in the depicted orientation) in the illustrated embodiment, in other embodiments the outlet portions can be directed in various other directions and/or other relative orientations (e.g., non-parallel).

The simplicity and performance of the microblower configuration of FIGS. 7-8 can, for example, enable a cost-effective solution for manufacture and/or other advantages.

As an alternative to the second housing 120, a connector 132 can be used, as shown in FIG. 11. The connector 132 can include an inlet portion 134 coupled to the outlet portion 124 of the first housing 118 and one or more outlet portions 136 (e.g., two in the illustrated embodiment) coupled to the conduits 108. The connector can be configured such that the outlets are oriented at various orientations relative to each other (e.g., a “T” connector or a “Y” connector).

The conduits 108 can be coupled to the second housing 120 or the connector 132 in various ways. For example, the conduits 108 can have a male portion coupled to or integrally formed thereon and which mates with a female portion of the second housing 120 or the connector 132. The male/female connection can include frictional engagement, snap-fit connections, locking connections, threaded connections, and/or various other types of connections.

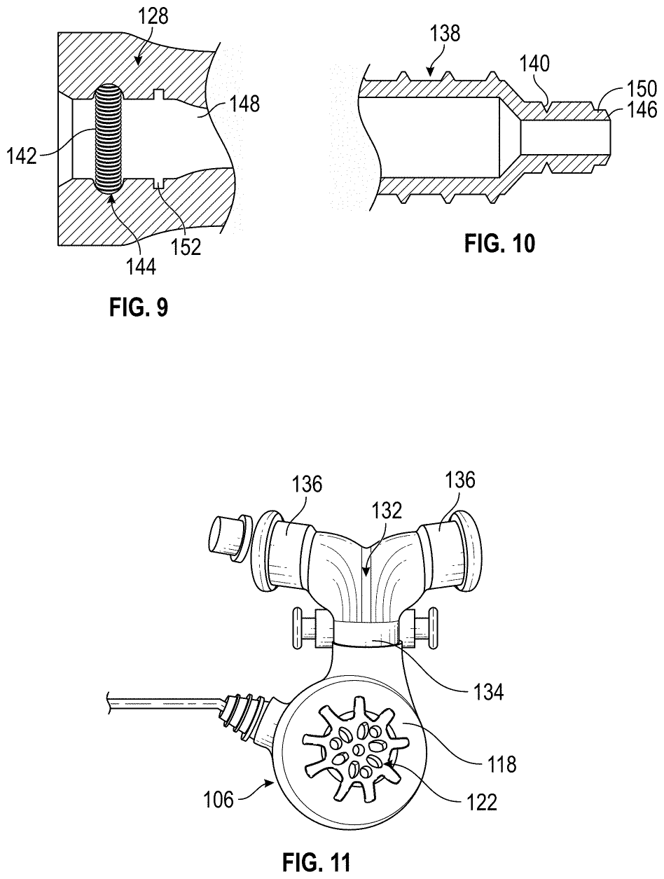

For example, the embodiment illustrated in FIGS. 8-10 depicts snap-fit type connections between the conduits 108 and the second housing 120. As shown, the conduits 108 can each include a male fitting 138 coupled thereto and which mates with a respective outlet portion 128 of the second housing 120 which acts as the female member. In some embodiments, the male fittings 138 of the conduits 108 can each include a first groove 140 that is configured to receive a projection (e.g., a spring) 142 (FIG. 9) that extends radially inwardly from a first notch 144 of the outlet portion 128. Additionally or alternatively, the male fittings 138 and the outlet portions 128 can also each have respective conical sealing surfaces 146, 148 that engage one another. Additionally or alternatively, the male fittings 138 can each include a surface 150 that is configured to engage a sealing member (e.g., an O-ring, which is not shown) that extends radially inwardly from a second groove 152 of the outlet portion 128.

It should be noted that the connector 132 can include connection features similar to those of the outlet portion 128 of the second housing 120. The connector 132 can alternatively include other types of connection features (e.g., threads) or can be coupled to the microblower and/or conduits 108 with fasteners (e.g., screws, bolts, clamps, etc.).

In some embodiments (e.g., those with only one cooling/heating zone), the second housing 120 or the connector 132 can be omitted and the outlet portion 124 of the first housing 118 can be coupled directly to the conduit 108.

For power, the microblower 106 can be coupled to one or more portable power supplies, including battery packs. For example, rechargeable batteries, power cells, and/or other energy storage devices can be used. For example, BB-2590, AN/PRC-148, and/or AN/PRC-152 batteries can be used. In another example, a PowerCore® portable power bank (manufactured by Anker® Innovations Limited of Hong Kong) can be used. In some embodiments, the power supply can include integrated controllers for varying the power to the microblower. This can function as a speed control mechanism for the microblower. In other embodiments, a controller can be a separate component that is connected to the microblower and the power supply (and/or a heater/chiller).

The vest 100 can include a pocket, strap, bag and/or other type of holding member to secure the power supply to the vest.

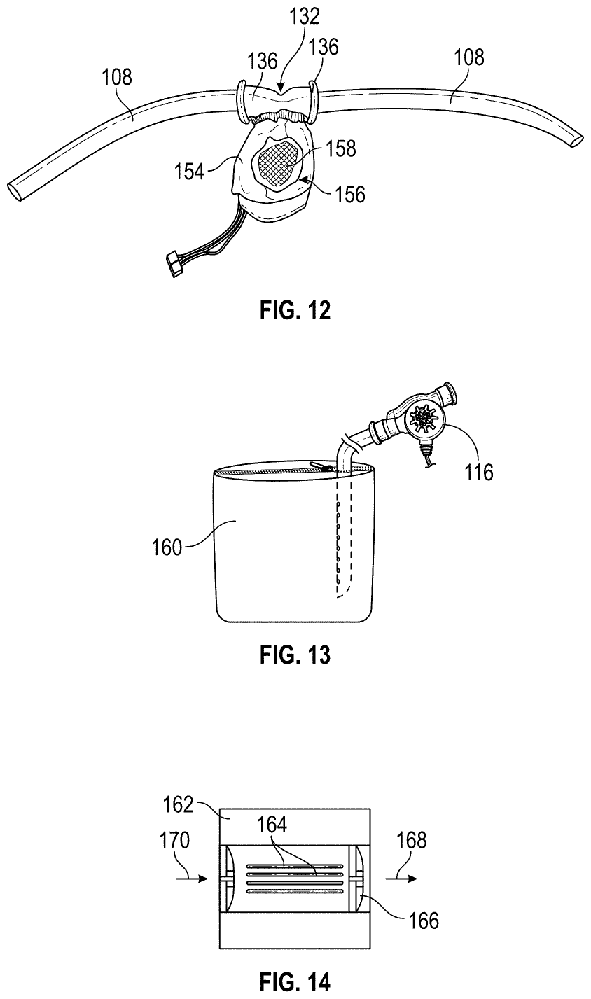

As shown in FIG. 12, the vest 100 can, in some embodiments, comprise a bag 154 configured to support and hold the microblower 106 (only the power cord of the microblower is shown in FIG. 12). The bag 154 can include an opening 156 aligned with the inlet portion 122 of the microblower thereby allowing airflow through the bag and into the microblower 106. In certain embodiments, the opening 156 can be partially covered with a mesh or screen 158. The screen 158 can optionally be configured to at least partially filter the air flowing into the microblower. This filtering feature can be particularly advantageous, for example, when a wearer of the vest is exposed to dusty, sandy, ashy, and/or other environments with particulates in the air. In some embodiments, the bag 154 can be entirely formed of mesh or other breathable material. In some embodiments, the bag 154 can comprise a foam laminate lining.

FIG. 13 shows an optional breathable (e.g., mesh) bag 160 that can be coupled to the flowing air (e.g., from the microblower 106). The bag 160 can be used, for example, for drying equipment, clothing, and/or other items. As shown, the bag 160 can be coupled to the microblower 106 with a conduit 108. The conduit can have one or more ports for distributing airflow throughout the bag 160. The bag 160 can also comprise an opening and a closure mechanism (e.g., a zipper, hook and loop, clips, buttons, etc.) coupled to the opening to secure the conduit and/or other contents within the bag.

In lieu of or in addition to the microblower, a MCHC device such as the vest 100 can include one or more passive (e.g., non-electrically powered) fluid pumps. These fluid pumps can include various types of pumping mechanisms that can be integrated with and/or coupled to the cooling/heating chambers 110 (e.g., via the conduits 108). In some embodiments, these pumping mechanisms can, for example, rely upon the wearer's movement to generate fluid flow.

For example, FIG. 14 shows an exemplary passive fluid pump 162. The fluid pump 162 can comprise one or more passages 164 configured to fill with fluid (e.g., air) and to collapse as the user undergoes common motions such as bending at the waist, walking, running, twisting, etc. Common motions such as these can force air out of the passages 164. One or more valves 166 (e.g., one-way and/or two-way) can be fitted to the passages 164. During compression of the passages 164, the trapped air is forced out of an outlet of the passages 164 towards the skin and/or into a conduit (e.g., in the direction indicated by arrow 168). During expansion of the passages 164, ambient air can be drawn into an inlet of the passages (e.g., in the direction indicated by arrow 170) from the outside providing needed cooling and relief from the humidity close to the skin. Additionally or alternatively, the valve for pumped air can be used to redistribute the displacement flow to other parts of the body.

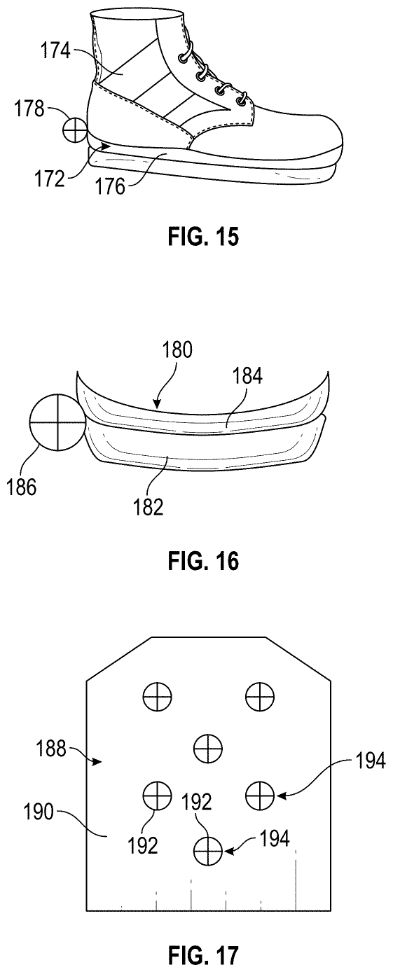

FIG. 15 shows another passive pumping mechanism 172 integrated into a footwear component 174. The pumping mechanism 172 can include one or more distribution passages 176 and one or more valves 178. The passages 176 can be compressed by the wearer is walking.

FIG. 16 shows yet another passive pumping mechanism 180 integrated into or coupled to a knee/elbow pad 182 (which are shown in cross-section). The pumping mechanism 180 can comprise one or more fluid passages 184 and one or more valves 186. The fluid passage 184 can be compressed (e.g., when the user kneels or bumps into something) and the valve 186 can regulate and/or direct the airflow to the wearer's body and/or into a conduit.

FIG. 17 shows another passive pumping mechanism 188 integrated into a vest 190 with the one or more valves 192 mounted at various points in the distribution passages 194.

Additional details about the disclosed microclimate heating and cooling (“MCHC”) devices and their components are provided below.

### Air Dispersion Garments

An air dispersion garment (e.g., a vest, or coupling device) creates an evaporative zone underneath close to the body (e.g., front and/or back) by introducing ambient air, cooled air, and/or heated air to the wearer's skin surface. In particular embodiments, the air dispersion garment is closely coupled to the body and capable of distributing injected air evenly.

### Microblowers and Motors

Optimizing a cooling system depends on balancing heat extraction rates with physical design parameters (e.g., weight, size, and/or power). For an air-cooled system, heat exchange is a function of air stream velocity, density, and temperature. Cooling, drying, or increasing the volumetric flow rates of the inlet air stream enhances heat removal. These three variables (i.e., cooling, drying, and/or flow) are the primary variables that can be considered along with the weight, size, and/or power requirements for the mechanism to enable effective heat removal. Passive mechanisms to control these three variables (that may not require external electrical power) are also described.

### Passive Cooling Effect

For maximum efficiency and to avoid counterproductive physiological responses, an effective microclimate device can maximize the body's natural thermoregulation mechanism, evaporation. Evaporation, or sweat, accounts for some 80% of heat removal during exertion, followed by convection.

If the sweat produced stays wet on the skin, the body's effort to give off heat is retarded. The surplus sweat, which drips off or is wiped away, is virtually useless for heat removal. However, air flowing around the wet body helps correct this situation. Water saturated air close to the body can be replaced by fresh air and evaporation can take place to remove the heat from the body.

In a still atmosphere, such as found underneath heavy garments and PPE (such as a fire protection garment) the air next to the skin is trapped by the clothing and becomes almost saturated. Its capacity to absorb and carry away moisture is severely limited.

A mechanism to provide for air flow where stagnant air is trapped next to the skin can help remove heat from the individual. Removal of water saturated air and providing drier air to the water laden areas will provide more evaporation and removal of heat from the body. Solutions to the problem of air flow to these restricted areas can include a small, high-efficiency, high-speed, and/or low-power motor/pump to provide the necessary air stream velocity (e.g., air flow). In these cases, an electrically-powered microblower can be used to actively provide the air movement.

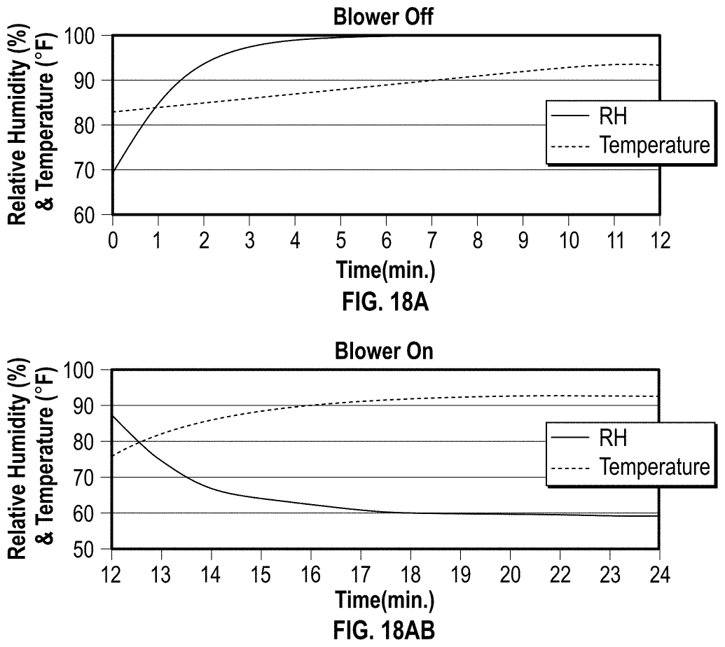

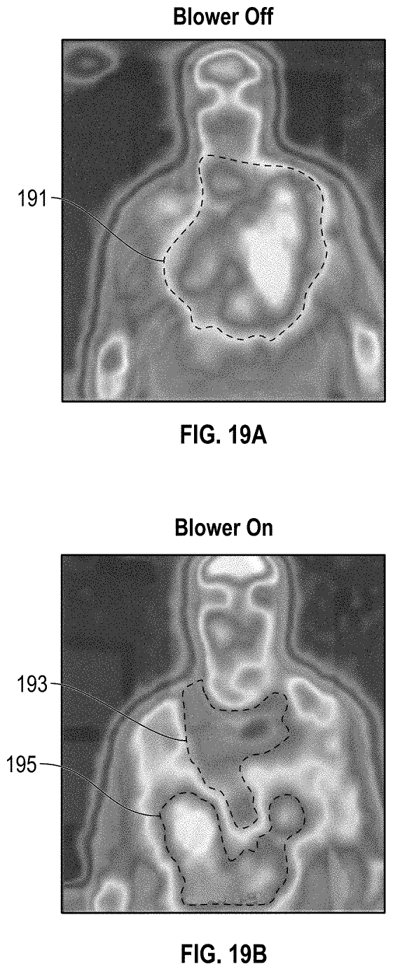

FIGS. 18A-19B illustrate the drying and cooling effects of the vest 100 from an exemplary test. FIGS. 18A-18B depicts the temperature and the relative humidity inside the vest during the test with the microblower “off” (FIG. 18A) and the microblower “on” (FIG. 18B). FIG. 19A depicts a thermal image of the wearer's body taken after the “microblower off” portion of the test, and FIG. 19B depicts a thermal image of the wearer's body taken after the “microblower on” portion of the test.

The test was performed in Baton Rouge, La. The ambient conditions for the test were: sunny, no cloud cover; 81° F.; wind 4-8 mph; relative humidity (“RH”) 50%. For the first portion of the test, the wearer wore the vest with the microblower “off” and walked approximately 3,600 feet at a brisk pace (approximately 12 minutes) while wearing a 100% white cotton T-shirt under a 100% polyester polo shirt. As shown in FIG. 18A, the temperature inside the vest rose steadily from about 80° F. to over 90° F., and the relative humidity rose quickly from about 70% to 100%. FIG. 19A shows a thermal image of the wearer after the vest was removed. The thermal images were taken using a VT04 Visual IR Thermometer manufactured by Fluke®. As shown, the wearer's core (e.g., chest) had a relatively large high heat area (illustrated by dashed boundary line 191).

For the second part of the test, the microblower was turned “on” and the wearer walked an additional 3600 feet (i.e., a total of 7200 feet) in approximately 12 minutes. As shown in FIG. 18B, the temperature inside the vest again rose from about 80° F. to about 90° F., but the relative humidity plummeted from about 90% to about 60%. As such, significant drying occurred during the second portion of the test even though the wearer exerted equal or additional energy compared to the first portion of the test. FIG. 19B shows a thermal image of the wearer after the second portion of the test. Due to the vest 100, the previous high heat area of the wearer's core significantly cooled and dried (see the “cool area” illustrated by the dashed boundary line 193). The wearer still had a high heat area (illustrated by the dashed boundary line 195), but its size is significantly reduced and its location is moved from the wearer's heart and lungs to a less critical area.

Other air movement mechanisms that can be utilized in a passive manner (e.g., not electrically) to emulate active fluid pumps are described below.

Air-cooling takes advantage of evaporative cooling from sweat and enhances convection cooling. In order for such convective air-cooling systems to work properly, the circulating air temperature should be lower than the skin temperature for cooling to occur by convection. As the inlet temperature of the circulating air lowers, heat transfer improves between the skin and air. For evaporative cooling to take place the liquid on the skin needs to undergo a state change from a liquid to a gas.

This heat, termed specific heat of evaporation, compared to the heat capacity of water is much larger. The specific heat capacity of water is much larger than the specific heat capacity of air. Therefore, evaporative mechanisms for heat transfer, due to the enormous quantities of heat required for the state change of water, are usually much more effective for heat transfer than simple conduction (and related convection) methods.

Convective cooling effect can be powerful method of cooling and is dependent upon manipulating one or more of the three variables (cooling, drying, and flow) identified above. Further, it does not require a great deal of power when properly implemented.

Convective cooling when used with evaporative cooling can be enhanced by wearing a high-performance fabric to aid in the transfer of sweat to a larger surface area. This fabric can 1) aid in transport of the liquid for evaporation, 2) provide high surface area for evaporation of the liquid, and/or 3) provide retention of the liquid. In this way the fabric can provide additional cooling that would be otherwise lost.

### Active Chiller/Heater Configuration

When the ambient temperature is above a certain threshold, the negative heating effects of the high temperature air can erode the value of the evaporative cooling afforded by the airflow. However, due to the large amount of heat absorbed by the phase change from liquid to vapor, cooling can be obtained even when the ambient temperature of the supplied air is above the temperature required for conductive cooling. This effect is readily apparent to anybody who has noticed the cooling effects of a warm wind on a wet object.

The less water (humidity) in the air, the lower the heat capacity of the circulated air. However, the lower the water content of the air, the less air needed to be circulated to evaporate a given amount of water if the circulation can bring the air into vapor equilibrium with the liquid water. In most cases, the advantages of dry air to help in the evaporative mechanisms of cooling will far out-weigh the reduction in the heat capacity of the dry air and its convective cooling ability. So, in some cases, it may be desirable to dehumidify the air prior to introduction of the air into the distribution device when cooling is desired. Dehumidification of the air by cooling can provide both cooler air and the capacity to evaporate more water as it is heated by distribution and circulation at the target. Alternative dehumidification techniques can be used (e.g., chemical drying agents).

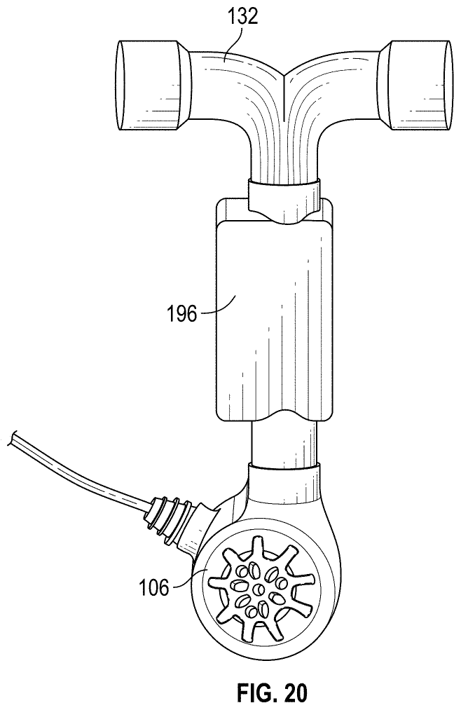

An active chiller/heater is a method that can, in some instances, require a significant amount of external power to enhance the air cooling or heating effect. An example of an active chiller/heater is a thermoelectric (or Peltier) heat pump. For example, FIG. 20 shows a chiller/heater mechanism 196 coupled to the microblower 106 and the connector 132. The chiller/heater mechanism 196 can be used to cool, dehumidify, and/or heat the accelerated air from the microblower 106.

### Alternative Active Heating

Methods to provide active heating in the circulation of air or in the passive circulation of air can be used. Use of Positive Temperature Coefficient (“PTC”) heaters to help limit the highest temperature of an electrical heater are viable alternative configurations for the heating element when active heating is required. For example, printed PTC heaters can be used.

It should be noted that the combination of heating and air circulation is a desirable configuration even when only heat is required. The passive or active circulation of ambient air, which is at a lower humidity than the air next to the skin, provides a drying effect to help regulate the body's sweat production when cold or hot. Thus, the comfort level provided by the device can be greatly enhanced when air circulation is combined with the heating that may be present by other means.

Any feature described herein, with regard to any example, can be isolated from one or more other features of the example. Any feature described herein can also be combined with one or more other features described in any one or more of the other examples.

In view of the many possible embodiments to which the principles of the disclosure may be applied, it should be recognized that the illustrated embodiments are only examples and should not be taken as limiting the scope of the claimed subject matter. The scope of the claimed subject matter is defined by the following claims and their equivalents.

1. A device comprising:
a wearable heater and/or cooler comprising:
one or more fluid pumps configured for generating flow of a fluid, wherein the fluid pumps comprise inlets and outlets;
one or more conduits having first end portions and second end portions, wherein the first end portions of the conduits are coupled to the outlets of the fluid pumps; and
one or more chambers coupled to second end portions of the conduits such that the fluid flows from the fluid pumps, through the conduits, and into the chambers, wherein chambers are configured for allowing the fluid to circulate adjacent to a wearer's body.

2. The device of claim 1, wherein one or more of the chambers comprises a chamber area configured to enhance desired thermal transfer characteristics between the wearer's body and the fluid.

3. The device of claim 1, further comprising one or more absorbent materials disposed within the chambers and configured to absorb fluid from the wearer's body.

4. The device of claim 3, wherein the absorbent materials includes a water-absorbing and high-surface area material.

5. The device of claim 1, wherein at least one of the fluid pumps is a passive fluid pump configured for generating flow of the fluid by movement of the wearer, wherein the passive fluid pump comprises one or more fluid passages and one or more one-way valves.

6. The device of claim 1, wherein at least one of the fluid pumps comprises an electrically-powered microblower.

7. The device of claim 1, wherein one or more of the chambers are configured to be placed at or adjacent to a core of the wearer.

8. The device of claim 7, wherein one or more of the chambers are configured to be placed at or adjacent to a chest of the wearer.

9. The device of claim 7, wherein one or more of the chambers are configured to be placed at or adjacent to a back of the wearer.

10. The device of claim 1, wherein one or more of the chambers are configured to be disposed at or adjacent to a foot of the wearer.

11. The device of claim 1, wherein one or more of the chambers are configured to be disposed at or adjacent to a head of the wearer.

12. The device of claim 1, wherein one or more of the chambers are configured to be disposed at or adjacent to a neck of the wearer.

13. The device of claim 1, wherein one or more of the chambers are configured to be disposed at or adjacent to a leg of the wearer.

14. The device of claim 13, wherein one or more of the chambers are configured to be disposed at or adjacent to a knee of the wearer.

15. The device of claim 1, wherein one or more of the chambers are configured to be disposed at or adjacent to an arm of the wearer.

16. The device of claim 15, wherein one or more of the chambers are configured to be disposed at or adjacent to an elbow of the wearer.

17. The device of claim 1, wherein the fluid pumps include at least one passive fluid pump and at least one active fluid pump.

18. The device of claim 1, wherein at least one of the fluid pumps comprises a housing with a plurality of outlets, wherein each outlet of the housing is configured to direct the fluid in a direction, the direction being different than a direction in which the other outlets of the housing direct the fluid, and wherein each outlet of the housing is coupled to a first end portion of a respective conduit.

19. A method comprising:
wearing a heater and/or cooler device, wherein the heater and/or cooler device includes:
a fluid pump configured for generating flow of a fluid, wherein the fluid pump comprises an inlet and an outlet;
a conduit having a first end portion and a second end portion, wherein the first end portion of the conduit is coupled to the outlet of the fluid pump;
a chamber coupled to the second end portion of the conduit such that the fluid flows from the fluid pump, through the conduit, and into the chamber, wherein chamber is configured for allowing the fluid to circulate adjacent to a wearer's body; and
activating the fluid pump to generate flow of the fluid from the fluid pump, through the conduit, and to the chamber.

20. The method of claim 19, wherein activating the fluid pump comprises compressing a fluid passage with a force generated by body weight or motion of the wearer.
